(19) United States
(12) Patent Application Publication
(10) Pub. No.: US 2023/0251406 A1
(43) Pub. Date: Aug. 10, 2023

(54) DYNAMIC MIRROR FOR A VEHICLE

(71) Applicant: SOLUTIA CANADA INC., VANCOUVER (CA)

(72) Inventors: JONATHAN ROSS SARGENT, VANCOUVER (CA); RYAN J. GIBSON, VANCOUVER (CA); JEREMY GRAHAM FINDEN, NORTH VANCOUVER (CA); NEIL ROBIN BRANDA, NORTH VANCOUVER (CA); GREG STUART, BURNABY (CA); JAMES DANIEL SENIOR, SURREY (CA); MATTHEW NEAL ROBERTS, VANCOUVER (CA)

(73) Assignee: SOLUTIA CANADA INC., VANCOUVER, BC (CA)

(21) Appl. No.: 18/010,193

(22) PCT Filed: Jul. 13, 2021
(86) PCT No.: PCT/CA2021/050962

§ 371 Date: Dec. 13, 2022

Related U.S. Application Data
(60) Provisional application No. 63/039,426, filed on Jun. 15, 2020.

(51) Int. Cl. G02B 5/08; G02F 1/157; G02B 5/23; B60R 1/08

(52) U.S. Cl. CPC G02B 5/0825; B60R 1/088; G02B 5/23; G02F 1/157

(57) ABSTRACT

Dynamic mirror assemblies are disclosed that can vary the amount of light reflected, that include a mirror and a switching material. The switching material is placed between the mirror and a viewer, and has a dark state and a light state, and switches state in at least one direction due to a photochromic reaction, and switches in the other direction due to one or more of a photochromic reaction or an electrochromic reaction or a thermal reversion above a threshold temperature.

### RELATED APPLICATION

The present application claims priority to U.S. Provisional Pat. Application US 63/039,426 filed Jul. 15, 2020, herein incorporated by reference in its entirety.

### TECHNICAL FIELD

The present disclosure relates generally to mirrors used in transportation, such as a side-view mirror or a rear-view mirror for a vehicle. The article is more specifically designed to lighten or darken using photochromic or hybrid photochromic/electrochromic or thermal reversion technology.

### BACKGROUND

A key safety aspect in the operation of automotive vehicles is the capability of the rear- and side-view mirrors to enhance the field of view of the vehicle’s operator. This capability can be significantly impaired upon the introduction of glare, a term used herein as a property caused by either sunshine in the daytime or a headlight of another vehicle at nighttime. Glare can result in difficulty in seeing clearly in the mirror due to the bright light of direct or reflected sunlight, or headlights of other vehicles, and is caused by a significant difference in light coming from what is being looked at (e.g., other vehicles) and the source of the glare.

Many automotive mirrors employ some type of anti-glare technology in order to improve visibility. Older mirrors employ a mechanical technology that adjusts the angle of the mirror such that the amount of reflected light is much reduced. Materials that can dynamically adjust the amount of light passing through them can also be used to make rear-view mirrors. Electrochromic mirrors, for example those made by Gentex Corporation of Zeeland, Ml, are well known in the art (e.g., patent no. US4443057).

Another example of using dynamic optical filters to deal with glare is the utilization of photochromic materials. US5373392 describes a “Photochromic Light Control Mirror” in which a photochromic material similar to those used in eyeglasses (e.g., US5274132 and US5369158) is darkened using a fluorescent UV light source. Like the eyewear technology, these photochromic switching materials rely on a thermal back reaction to drive the transition back to the light state. The thermal back reaction occurs naturally during normal operating temperatures of the mirror. However, the rate of the thermal back reaction and the extent of the reaction is affected by the temperature experienced by the mirror. As a result, the dark state achieved and the rate of switching of such existing photochromic technologies is significantly dependent on temperature. In colder temperatures, the photostationary state of the photochromic media will shift such that the mirror will become much darker due to a slower thermal back reaction, possibly too dark for effective use. Conversely, in warmer temperatures, the photostationary state of the photochromic media will shift such that the mirror will become less dark due to a faster thermal back reaction, possibly too light for effective use, a disadvantage that would be apparent in the low reflectivity state or night mode.

Another issue that arises is that some of these technologies are controlled by a continuous light source, as in US20050270614A1. In other words, a light source emitting a specific wavelength needs to be on continuously to darken the photochromic material and to keep it dark, increasing the overall power consumption. A resulting problem then also arises of dissipating the heat generated from this continuous light source, as this heat will increase the degradation rate and further alter the photostationary state of the photochromic material.

### SUMMARY

In another aspect, the invention relates to dynamic mirror assemblies that can vary the amount of light reflected. According to the invention, the dynamic mirrors include a mirror, and a switching material, placed between the mirror and a viewer, having a dark state and a light state, that switches state in at least one direction due to a photochromic reaction, and that switches in the other direction due to one or more of a photochromic reaction or an electrochromic reaction or a thermal reversion above a threshold temperature.

Further aspects of the invention are as disclosed and claimed herein.

### BRIEF DESCRIPTION OF THE DRAWINGS

These and other features will become more apparent from the following description in which reference is made to the appended drawings. The figures are for illustrative purposes, and unless indicated otherwise, may not show relative proportion or scale.

FIG. 1 shows an exploded view of a mirror according to one example.

FIG. 2 shows an exploded view of a mirror according to another example.

FIG. 3 shows an exploded view of a mirror according to another example.

FIG. 4 shows an exploded view of a mirror according to another example.

FIG. 5 shows a schematic diagram of a mirror according to another example.

FIGS. 6a, 6b, 6c and 6d show embodiments of a prototype mirror according to another example.

FIG. 7 shows a schematic of a simple circuit for powering the LEDs used for darkening and lightening the mirror.

FIG. 8 shows one embodiment of the LED circuit on a circuit board.

FIGS. 9a, 9b, 9c, and 9d show LED arrangements according to different embodiments.

FIG. 10 shows a generalized circuit for darkening and lightening LEDs.

### DETAILED DESCRIPTION

The current invention relates in various aspects to dynamic mirrors such as rear-view and side view mirrors for vehicles, and in particular automobiles, that have variable reflectivity. That is, the amount of light that the mirrors reflect can be varied depending on the situation, for example to reduce glare from headlights on following cars at nighttime. The mirror may comprise a switching material comprising for example a photochromic or photochromic/electrochromic material that can be selectively lightened or darkened, thereby causing the mirror to reflect more or less light either through user control or through an automatic system based on time and/or geographic position and/or sensor input.

In one aspect, then, the invention relates to dynamic mirror assemblies that can vary the amount of light reflected, that include a mirror and a switching material. The switching material is placed between the mirror and a viewer, has a dark state and a light state, and switches state in at least one direction due to a photochromic reaction, and switches in the other direction due to one or more of a photochromic reaction or an electrochromic reaction.

In one aspect, the mirror is highly reflective in the visible light region and highly transmissive in the ultraviolet region. In one aspect the mirror may be a reciprocal mirror that appears reflective on one side and transparent on the other.

In an aspect, the switching material comprises a chromophore that switches state in at least one direction due to a photochromic reaction, and that switches in the other direction due to one or more of a photochromic reaction or an electrochromic reaction.

In another aspect, the switching material may further comprise a polymer such as polyvinyl butyral. In yet another aspect, the mirror may comprise one or more of gold, chromium, aluminum, or silver, sputtered onto a transparent substrate.

In a further aspect, the mirror may comprise a multilayered dielectric material having alternating layers of high and low refractive index materials.

In yet another aspect, the chromophore used may switch via a photochromic reaction to the dark state when excited by light of one wavelength range, and switch via a photochromic reaction to the light state when excited by light of a different wavelength range.

In a further aspect, the dynamic mirror assemblies of the invention may further comprise light-emitting diodes, on a side of the mirror opposite the switching material, that emit at a fixed wavelength range to drive one of the state changes. In yet another aspect, the light-emitting diodes may drive the switching material from the light state to the dark state. In a further aspect, light-emitting diodes may be used that have a fixed wavelength that is from about 350 nm to about 410 nm and serves to darken the switching material. In yet another aspect, the dynamic mirror assemblies may include additional light-emitting diodes that emit light within a wavelength range from 450 nm to 800 nm to lighten the switching material.

According to the invention, the dynamic mirror assemblies may further comprise a filter, between the switching material and sunlight, such that filtered sunlight transitions the switching material from the dark state to the light state.

In another aspect, the switching material may comprise a photochromic-electrochromic material, and the switching material may darken in response to light and lighten in response to electricity. In yet another aspect, the switching material may comprise a photochromic-electrochromic material, and the switching material darken in response to light and lighten in response to electricity. According to aspects of the invention, the photochromic-electrochromic material may comprise one or more chromophores.

In other aspects, the switching material may be either a photochromic or a photochromic-electrochromic switching material, and may comprise a P-Type photochromic material.

In one aspect of the dynamic mirror assemblies of the invention, the dark state of the switching material does not spontaneously revert to the light state upon removal of a light source over a temperature range from -20° C. to 50° C., or over a temperature range from -30° C. to 60° C., or over a temperature range from -40° C. to 70° C. In another aspect, the dynamic mirror assembly has a day mode and a night mode, and the mirror assembly is in a high reflectance state during the day mode and in a low reflectance state during the night mode.

In one aspect, the dynamic mirror assemblies of the invention may comprise a controller that controls whether the mirror should be in day mode or night mode based on one or more of a clock, a light sensor, or a GPS signal. In another aspect, the dynamic mirror assemblies of the invention may further include a controller that can place the mirror in intermediate states between the dark state and the light state according to manual input, or automatically based on one or more of a clock, a light sensor, or a GPS signal.

In another aspect, the invention relates to a dynamic mirror assembly that can vary the amount of light reflected, that includes a mirror, and a switching material. The switching material is placed between the mirror and a viewer, has a dark state and a light state, and switches state in at least one direction due to a photochromic reaction, and that switches in the other direction due to one or more of a photochromic reaction, or an electrochromic reaction, or a thermal reversion above a threshold temperature.

In aspects, the switching material switches in the other direction due only to a photochromic reaction, due only to an electrochromic reaction, or due to both a photochromic reaction and an electrochromic reaction.

In another aspect, the switching material switches in the other direction due only to thermal reversion above the threshold temperature.

In an aspect, the mirror is highly reflective in the visible light region and highly transmissive in the ultraviolet region.

In another aspect, the mirror is a reciprocal mirror that appears reflective on one side and transparent on the other.

In a further aspect, the switching material comprises a chromophore that switches state in at least one direction due to a photochromic reaction, and that switches in the other direction due to one or more of a photochromic reaction or an electrochromic reaction or a thermal reversion above a threshold temperature.

In one aspect, the switching material further comprises polyvinyl butyral.

In an aspect, the mirror may comprise one or more of gold, chromium, aluminum, or silver sputtered onto a transparent substrate. In another aspect, the mirror may comprise a multilayered dielectric material having alternating layers of high and low refractive index materials.

In an aspect, the chromophore switches via a photochromic reaction to the dark state when excited by light of one wavelength range, and switches via a photochromic reaction to the light state when excited by light of a different wavelength range.

According to the invention, the dynamic mirror assembly may further comprise light-emitting diodes, on a side of the mirror opposite the switching material, that emit at a fixed wavelength range to drive one of the state changes. In an aspect, the light-emitting diodes may drive the switching material from the light state to the dark state. In another aspect, the fixed wavelength is from about 350 nm to about 410 nm and serves to darken the switching material.

In one aspect, the dynamic mirror assembly of the invention may further comprise additional light-emitting diodes that emit light within a wavelength range from 450 nm to 800 nm to lighten the switching material. In another aspect, the dynamic mirror assemblies of the invention may further comprise a filter, between the switching material and sunlight, such that filtered sunlight transitions the switching material from the dark state to the light state.

In one aspect, the switching material comprises a photochromic-electrochromic material, and the switching material darkens in response to sunlight and lightens in response to electricity. In another aspect, the switching material comprises a photochromic-electrochromic material, and the switching material darkens in response to light and lightens in response to electricity. In yet another aspect, the switching material comprises a P-Type photochromic material.

In yet another aspect, the switching material may comprise a photochromic material that switches to the light state photochromically and switches to the dark state due to thermal reversion above the threshold temperature. In a further aspect, the switching material comprises a photochromic material that switches to the dark state photochromically and switches to the light state due to thermal reversion above the threshold temperature.

In various aspects the threshold temperature useful according to the invention is at least 50° C., or at least 60° C., or at least 70° C.

In an aspect, the dark state of the switching material does not spontaneously revert to the light state upon removal of a light source over a temperature range from -20° C. to 50° C., or over a temperature range from -30° C. to 60° C., or over a temperature range from -40° C. to 70° C.

In an aspect, the dynamic mirror assembly of the invention has a day mode and a night mode, and the dynamic mirror assembly is in a high reflectance state during the day mode and in a low reflectance state during the night mode.

In one aspect, the dynamic mirror assembly of the invention comprises a controller that controls whether the dynamic mirror assembly should be in day mode or night mode based on one or more of a clock, a light sensor, or a GPS signal. In another aspect, the dynamic mirror assembly of the invention comprises a controller that can place the dynamic mirror assembly in intermediate states between the dark state and the light state according to manual input, or automatically based on one or more of a clock, a light sensor, or a GPS signal.

In one aspect, the switching material switches state in at least one direction due to a photochromic reaction, and switches in the other direction due to thermal reversion, and the threshold temperature is higher than the regular operational temperature range of the dynamic mirror. In another aspect, the dynamic mirror assembly of the invention may further comprise a heating element that drives the switching material in the other direction due to the thermal reaction that occurs.

In yet another aspect, the switching material comprises a chromophore that darkens due to a photochromic reaction and lightens due to thermal reversion that occurs above the threshold temperature. In further aspects, the threshold temperature is greater than 60° C., or greater than 70° C., or greater than 80° C., or greater than 90° C.

When we say that the dynamic mirror assemblies of the invention have a switching material that has a dark state and a light state, we refer to two relative states, the dark state being one in which the amount of light transmitted is lower than the amount of light transmitted in the light state. Relative intermediate states between the light state and the dark state are possible and desirable, and each intermediate state will be understood to be lighter or darker than another state. Because the switching material is placed between the mirror and a viewer, the dark state will cause the assembly to reflect less light from the mirror than will the light state.

When we refer to a photochromic reaction, we mean one that lightens or darkens a material when exposed to light, thus affecting the dark or light state of the material. When we refer to an electrochromic reaction, we mean one that lightens or darkens a material when exposed to an electrical current, thus affecting the dark or light state of the material. When we refer to a thermal reversion above a threshold temperature, we mean a reversion to a more thermodynamically-stable state above a threshold temperature that serves to lighten or darken a material when exposed to temperatures above the threshold temperature, thus affecting the dark or light state of the material. When we say that the switching material, having a dark state and a light state, switches state in one direction or another, we mean that it changes from a light state to a dark state, or from a dark state to a light state, in relative terms, as already described.

The switching material will be understood to typically comprise at least one chromophore, and may comprise more than one chromophore. The chromophore may, for example, be a P-type chromophore that is bistable, meaning that once the chromophore is in the dark state, it will stay in that state until subjected to a stimulus to transition them away from that state. Examples of possible stimuli that can be used to transition the chromophore from one state to another include light of an appropriate wavelength, electricity of an appropriate voltage, or, for thermal reversion an amount of heat required to raise the temperature of the system above a threshold temperature.

The present invention provides, in part, a vehicle mirror that comprises photochromic switching materials which, upon subjection to a light source, will darken in response to said light source, minimizing the transmission of light to the operator of the vehicle.

The mirror may function in two modes: the first, “night mode”, will ensure the mirror reflects a lower percentage of incident light, to reduce any glare to the vehicle operator that may be associated with any following vehicles. The second, “day mode”, will allow the mirror to reflect a higher percentage of incident light.

An optional third mode will encompass aspects of the first and second modes, in that it is able to rapidly dim or lighten in response to changing environments (e.g. introduction of a need for low transmission, such as entering a tunnel while driving during the day).

In another aspect, the vehicle mirror may be self-dimming or self-lightening, in that a control mechanism will automatically respond to changes in ambient light conditions.

In another aspect, the self-dimming mirror is capable of achieving intermediate states in between the day and night modes. Intermediate states may be set by the user, or based on light sensors and on time of day.

In another aspect, the self-dimming mirror may include an auto reset from “night mode” to “day mode” when the vehicle is parked at night or when a driver enters the vehicle during the day.

In another aspect, the self-dimming mechanism of the mirror may be achieved by the use of a light-emitting diode (LED) light source. This light source may include LEDs that emit a range of wavelengths, for example, of less than 300 nm, between 300 - 700 nm, or greater than 700 nm, or a combination of the aforementioned ranges. In a related aspect, one range of wavelengths may be used to drive the photochromic material of the mirror to a darkened state, while another range of wavelengths may be used to lighten the material.

In another related aspect, the photochromic material may also be electrochromic, and one reaction (for example, the photochromic mechanism) may be used to darken the material while the other reaction (for example, the electrochromic mechanism) may be used to lighten the material. The photochromic mechanism may be achieved by subjecting the material to an LED light source, while the electrochromic mechanism may be induced by the application of an electric voltage.

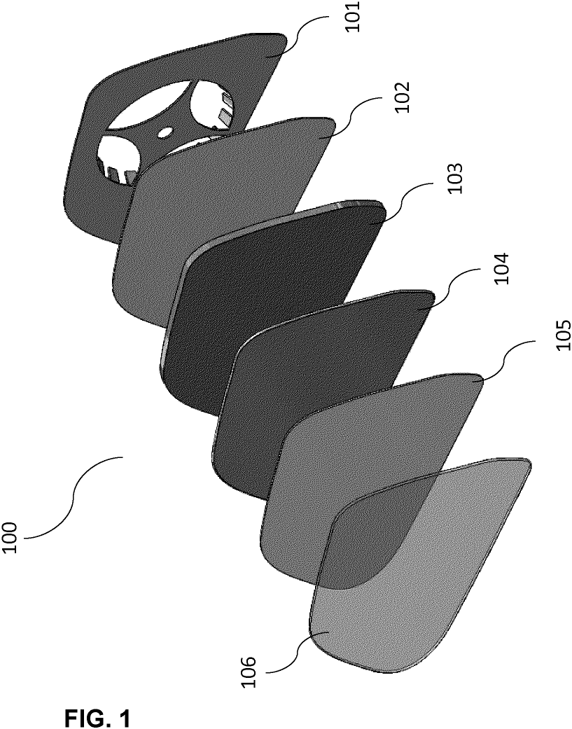

In another aspect, the photochromic material may transition from the dark state / low reflectance state to the light state / high reflectance state above a certain temperature threshold, wherein the photochromic mechanism may be used to darken the material while the thermal lightening mechanism may be used to lighten the material. The thermal lightening reaction would occur above a threshold temperature that is above the normal operating temperature range of the mirror. Referring to FIG. 1, an example of a rear-view mirror is shown as an exploded assembly 100. The mirror could be, for example, a rear-view mirror in a vehicle or a side-view mirror. In this example, the mirror is photochromic; darkening in response to light of one wavelength range, and lightening in response to light of a second wavelength range. A backing plate 101 is used to attach the photochromic mirror assembly to the mechanical part of existing mirror systems that allows for mounting to the vehicle as well as for aiming of the mirror. A light-emitting diode (“LED”) light array 103 is either bonded to the backing plate, or mechanically attached.

This light-emitting diode (“LED”) light array 103 may be a light guide panel with edge-lit LEDs. It may have a reflective backing to direct more light from the LED towards adhesive layer 105. It may be glass, for example, or plastic or silicone, specifically liquid-injection-molded silicone. It is ideally highly transmissive in the UV range. It may have a light diffuser on the side closer to the adhesive layer 105. It should ideally withstand exposure to UV light. There may be optional filters provided, that block visible light configured between the LEDs and the light guide panel, to filter out low levels of visible light emitted (bleed into the visible region) by the UV LEDs. Also, the filter may optionally be configured between the LED array 103 and the mirror 104.

A mirror 104, is attached to the LED array 103. Mirror 104 should have high reflectivity in the visible light region of the electromagnetic spectrum and high transmission in the UV region of the electromagnetic spectrum. Mirror 104 may be a half-silvered mirror formed by either sputtering gold, chromium, aluminum or silver onto a glass or transparent surface, or a laminated polyethylene terephthalate (“PET”) film. Mirror 104 may also be a multilayered dielectric coating with alternating layers of high and low refractive index materials of specified layer thicknesses so as to achieve the indicated reflection and transmission properties. Other mirrors as known in the art are possible. Mirror 104 may be curved to form a concave or convex surface. An optional resistive heating element 102 may be adhered between the backing plate 101 and the LED light array 103, or between the LED light array 103 and the glass 104. Adhesive layer 105 comprises a switching material that may contain one or more photochromic dyes and be bonded to outer layer 106.

Layer 105 may comprise one or more layers of polyvinyl butyral (“PVB”), poly(ethylene-vinyl acetate) (“PEVA” or “EVA”), pressure-sensitive adhesive (“PSA”) or any combination of the aforementioned. In one example, this adhesive layer is separated into two parts, the first inner part containing the photochromic dye(s) and the second outer part containing UV-absorbing materials or UV absorber (“UVA”). Layer 105 may also be an adhesive stack formed by laminating a PET film containing the dye, between two layers of adhesive. The outer layer of this adhesive stack may contain a UVA. An outer layer 106 is bonded to layer 105 and may be comprised of either glass or plastic. Outer layer 106 may be labeled or etched with text, or may have patterns to mask functional elements of the embodiment such as edge seals. In another example, outer layer 106 is preferentially comprised of glass, which may be curved, to form a concave or convex mirror, or not curved. Outer layer 106 may also include coatings on either the inside or outside surfaces. Coatings may include UV absorbers that will block 99.5% or more of a UV light source. These coatings may be adhered to either surface of outer layer 106 by sputtering, or they may be flow coated in an organic matrix. Any UV absorber in layer 105 or 106 would adsorb UV light (and/or high energy visible light) that causes a photochromic darkening reaction in some photochromic dyes.

In an embodiment, the layer 105 may comprise a layer-by-layer coating, such as disclosed and claimed in U.S. Pat. No. 9,453,949, the disclosure of which is incorporated herein by reference, containing a dye-containing layer coated onto a polymer substrate such as PET. In this aspect, a layer-by-layer coating may be used that comprises a polymeric substrate and a composite coating including a first layer and a second layer. Typically, the first layer is immediately adjacent the polymeric substrate at its first face and the second layer is immediately adjacent to the first layer at its opposite face. This first layer includes a polyionic binder while the second layer includes the dye. Each layer includes a binding group component with the binding group component of the first layer and the binding group component of the second layer constituting a complimentary binding group pair.

As used herein, the phrase “complementary binding group pair” means that binding interactions, such as electrostatic binding, hydrogen bonding, Van der Waals interactions, hydrophobic interactions, and/or chemically induced covalent bonds are present between the binding group component of the first layer and the binding group component of the second layer of the composite coating. A “binding group component” is a chemical functionality that, in concert with a complimentary binding group component, establishes one or more of the binding interactions described above. The components are complimentary in the sense that binding interactions are created through their respective charges.

Typically, these layer-by-layer coatings comprise a plurality of these composite coatings. The number of layers of composite coatings is not intended to be limiting in any way on the possible number of composite coatings and one of ordinary skill will appreciate that this description is simply exemplary and illustrative of an embodiment with multiple or a plurality of composite coatings.

In one example, the side-view mirror uses sunlight to transition to the lighter (higher reflectance) state for a “day mode”, and UV light from the LED light array 103 for transitioning to the darker (lower reflectance) state for a “night mode”. Under daylight conditions filtered sunlight will drive a photochromic reaction in layer 105 that causes the photochromic layer to transition to the light state. In this scenario the UV component of sunlight is filtered, and the photochromic layer is exposed only to lower energy visible light, which results in the photochromic lightening of the active layer. Day mode can be triggered simply by the presence of sunlight. Under low light or high glare conditions the UV LEDs in LED array 103 can be switched on to activate or darken the photochromic layer, transitioning the mirror to the low reflection state for night mode operation.

Mirror 104 allows transmission of the UV backlight from the LED array 103 to the photochromic switching material in layer 105. This enables darkening of the photochromic layer and reflects the visible component of light transmitted through the outer layer 106, therefore acting as a mirror. The speed of switching of the photochromic material can be fast; for example, it may have a switching half-life within a few minutes, or even within seconds. The outer layer 106 with UV cut-off protects the user from the exposure to the UV from LED array 103, and also serves the dual purpose of preventing darkening of the mirror during the day. One of skill in the art will understand that many commercial UV LEDs have a light emission profile such that there may be low levels of visible light emitted (bleed into the visible region). To prevent the consumer from seeing this light, mirror 104 may be backed with a filter that blocks transmission of visible light. One commercially available example of such a filter is UG11 from Schott. Night mode can be triggered automatically by a clock either alone or combined with a GPS to indicate vehicle location, it can be triggered by the user, or it can be triggered by sensor readings. Once the UV backlight is switched off, the low reflection state in this example persists until daytime, when exposure to sunlight causes a photochromic lightening reaction that restores the mirror to a high reflection state. The photochromic layer may contain one or multiple chromophores. Elements 106, 105 and 104 may be laminated together providing a mirror laminate with high structural integrity allowing the use of thinner, for example chemical-treated glass, for example Gorilla® Glassfrom Corning® or Dragontrail™ glass from AGC, or plastic layers for reducing weight of the mirror assembly and providing NVH benefits. Chemical-treated glass is known in the art to be stronger and lighter, allowing thinner panes or panels to be used.

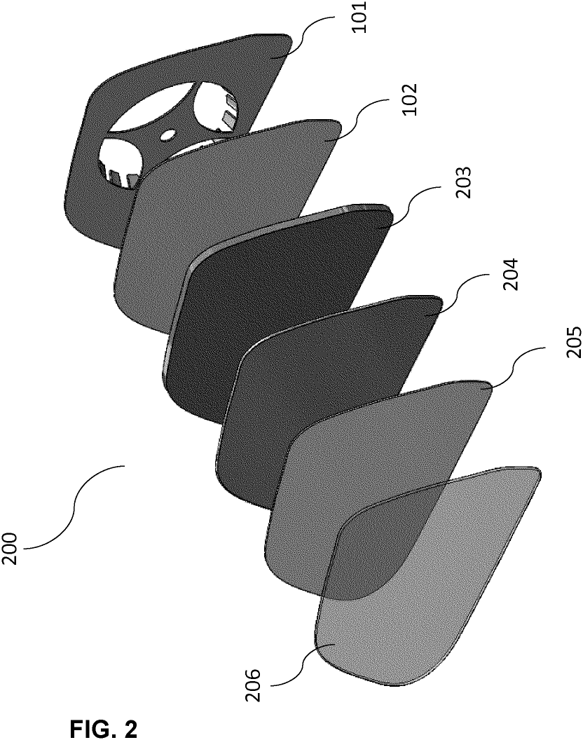

Referring to FIG. 2, a second example is shown generally as an exploded assembly 200. Whereas the LED array 103 in FIG. 1 is comprised of only one type of LED light (UV lights for darkening the photochromic layer 105), the LED light array 203 in FIG. 2 is comprised of two types of LED lights. The first type of LED emits one range of wavelengths suitable for darkening the photochromic layer 205, and the second type of LED emits a second different range of wavelengths suitable for lightening the photochromic layer 205. In an example, the LED light array 203 comprises LEDs emitting light with wavelengths in the range of 350 - 410 nm to darken the photochromic layer 205, as well as LEDs emitting light with wavelengths in the range of 450 - 800 nm for lightening the photochromic layer 205. Alternatively, LED arrays can also be located at the side of the mirror with diffusers or light guides directing the light to the photochromic layer. Thus, element 203 can be a light guide panel with edge-lit LEDs. It may have a reflective backing to direct more light from the LED towards photochromic layer 205. It may be glass, or plastic or silicone, specifically liquid-injection-molded silicone. It is ideally highly transmissive in the UV range. It may have a light diffuser on the side closer to 205. It should ideally withstand exposure to UV light and visible light. There may be filters that block visible light configured between the LEDs and the light guide panel to filter out low levels of visible light emitted (bleed into the visible region) by the UV LEDs, but allow light of wavelengths corresponding to the second LED in array 203. Also, the filter may optionally be configured between the LED array 203 and the mirror 204.

Array 203 is either bonded to backing plate 101 or mechanically attached. A mirror 204, is attached or adjacent to LED array 203. Mirror 204 should have high transmission in the UV region of the electromagnetic spectrum, high reflectivity in the majority of the visible light region of the electromagnetic spectrum, but also high transmission of visible light at the specific wavelength corresponding to the visible LEDs on LED array 203. The mirror 204 may be curved to form a concave or convex surface. In addition, the mirror 204 may have a polarized coating or a polarized film that may be attached using transparent PSA. An outer layer 206 is bonded to layer 205 and is comprised of either glass or plastic. Outer layer 206 may be labeled or etched with text or may be patterned to mask functional elements of the example such as edge seals. In another example, outer layer 206 is comprised of glass, which is curved to form a concave or convex mirror. Outer layer 206 may include coatings on either the inside or outside surfaces. Coatings may include UVAs that will block 99.5% or more of a UV light source. These coatings may be adhered to either surface of outer layer 206 by sputtering, flow coating an organic matrix, or other deposition technologies known in the art. Outer layer 206 may also comprise a polarized filter, either coated or attached to one face of layer 206 using a plastic film and PSA. The polarized filter of layer 206 must be perpendicularly aligned to the polarized coating or film of mirror 204.

The example described with reference to FIG. 2 operates with active lightening functionality (visible LEDs) instead of the passive lightening (filtered sunlight). This means that that sunlight is not required to lighten the mirror to put it back into day mode. Even at night the mirror could be switched to provide higher reflectivity. As with the previous example, the mirror can also operate with a day mode and night mode that is either controlled automatically based on time and/or GPS, or based on sensor input, or based on some other feedback. The mirror can also be controlled manually based on user interaction.

In an example of automatic operation, detection of bright ambient lighting conditions (eg. daylight) can cause the visible LEDs in the LED array 203 to be switched on, which lightens the photochromic layer 205 and achieves the high reflectance state. Using visible LEDs, the lightening of the photochromic layer occurs when light from the visible LED passes through the mirror 204 and its associated linear polarizer to reach the photochromic layer 205, triggering the photochemical lightening reaction to achieve the high reflectance state. Any remaining polarized visible light that is transmitted through the photochromic layer is blocked by the linear polarizer on or attached to outer layer 206. Since the linear polarizer on or attached to outer layer 206 is a crossed polarizer with respect to the linear polarizer on 204, no UV light escapes from the front face of the mirror, thereby protecting the user from the LED light. In an aspect, the layer 205 may comprise a layer-by-layer coating, as described above, containing a dye-containing layer coated onto a polymer substrate such as PET.

Similarly, when the onboard light sensors detect low ambient light conditions (e.g., nighttime or tunnel), the UV LED is activated, darkening the photochromic layer to achieve the low reflectance state. The crossed polarizers and/or the optional UV absorber in layer 205 prevent light from the UV LEDs in LED array 203 from escaping the side view mirror assembly in the same way as described above for the visible LEDs. Thus, element 203 can be a light guide panel with edge-lit LEDs, as already described. None of the light from LED array 203 (UV or visible), or minimal amounts of it, is able to exit the side view mirror assembly. The UV filter on the outer glass layer 206 also ensures that inadvertent darkening of the photochromic layer 205 due to sunlight does not occur. The mirror 204 reflects incident sunlight providing the mirror functionality for both the high and low reflectance states. Additional light filtering strategies to ensure no light is able to exit the mirror assembly are possible. For example, the pair of crossed polarizers may be replaced by two circular polarizers, where a first polarizer is a right circular polarizer and the second is a left circular polarizer. In a second example, the pair of crossed polarizers may be replaced by a single notch filter on the outer glass, which is selected such that the wavelength of light generated by the visible LED backlight is centered in the reflectance band of the notch filter. In a third example, the crossed polarizers may be replaced with a light guide layer between the LED array 203 and the mirror 204 to minimize light exiting the mirror assembly in the direction of the driver or vehicle occupants, One commercially available example of such a light guide layer is ALCF-A2+ from 3M™. Elements 206, 205 and 204 may be laminated together providing a mirror laminate with high structural integrity allowing the use of thinner glass, for example chemical-treated glass, for example Gorilla® Glass from Corning® or Dragontrail™ glass from AGC, or plastic layers for reducing weight of the mirror assembly and providing NVH benefits. Chemical-treated glass is known in the art to be stronger and lighter, allowing thinner panes or panels to be used.

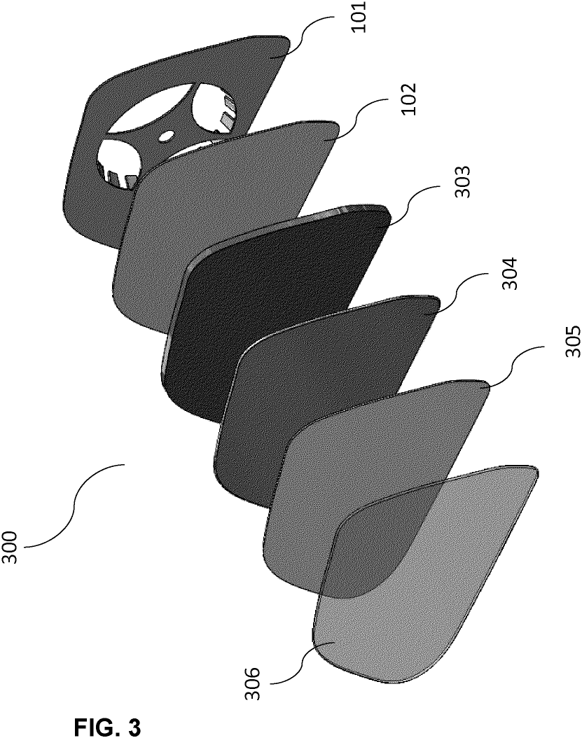

Referring to FIG. 3, a third example is shown generally as an exploded assembly 300. An outer layer 306 comprised of either glass or plastic is bonded to layer 305. Layer 305 comprises a photochromic material. In an aspect, the layer 305 may comprise a layer-by-layer coating, as described above, containing a dye-containing layer coated onto a polymer substrate such as PET. In this example, outer layer 306 comprises a notch filter to block a narrow band of light. These notch filters may be absorptive or dichroic type filters applied as a coating on outer layer 306, or adhered to outer layer 306 using a transparent PSA. The absorptive notch filter may also use a split layer adhesive layer with a dye present that absorbs light from the second visible LED array. The notch filter can be used in place of the polarizing layer to allow visible light in and out of the mirror, but to block the particular wavelength emitted by the LEDs on LED array 303. LED array 303 may comprise coloured LEDs emitting in the 450 - 800 nm wavelength range. For example, if the LEDs emit light with a wavelength of 650 nm, the notch filter on outer layer 306 could be chosen such that all visible wavelengths are allowed to pass but the wavelengths at 650 nm and just around that peak are blocked, thereby preventing light from the 650 nm LEDs from escaping. Outer layer 306 may also be labeled or etched with text, or may be included to mask functional elements of the example such as edge seals. In one example, outer layer 306 is preferentially comprised of glass, which is curved to form a concave or convex mirror, in particular to form a rear-view or side-view mirror of a vehicle. Outer layer 306 may include coatings on either the inside or outside surfaces. Coatings may include UV absorbers that will block 99.5% or more of a UV light source. These coatings may be adhered to either surface of outer layer 306 by sputtering, flow coating in an organic matrix, or other deposition technologies known in the art. Mirror 304 should have high transmission in the UV region of the electromagnetic spectrum, high reflectivity in the majority of the visible light region of the electromagnetic spectrum, but also high transmission of visible light at the specific wavelength corresponding to the visible LEDs on LED array 303. Elements 306, 305 and 304 may be laminated together providing a mirror laminate with high structural integrity allowing the use of thinner glass, for example chemical-treated glass, for example Gorilla® Glass from Corning® or Dragontrail™ glass from AGC, or plastic layers for reducing weight of the mirror assembly and providing NVH benefits. Chemical-treated glass is known in the art to be stronger and lighter, allowing thinner panes or panels to be used.

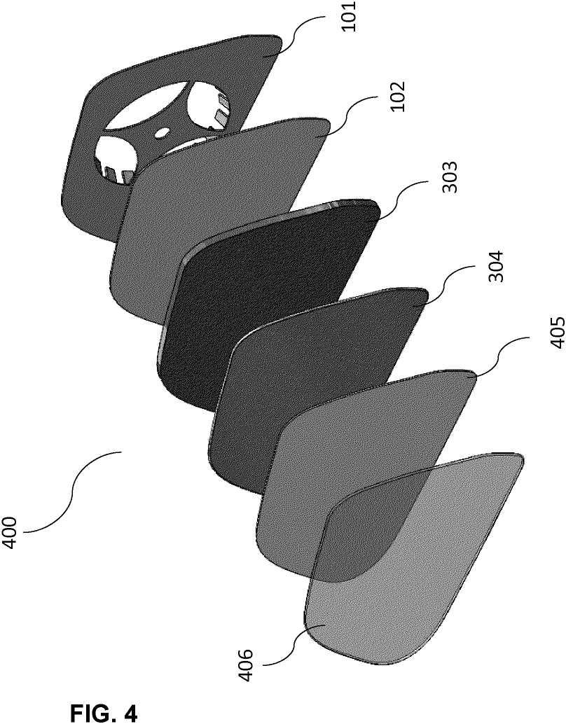

Referring to FIG. 4, a fourth example is shown generally as an exploded assembly 400. Adhesive layer 405 may comprise a PVB- or EVA-encapsulated film, and this film may contain a hybrid photochromic-electrochromic dye. With photochromic-electrochromic switching materials, one of the transitions (either light to dark or dark to light) occurs in response to light, and the other transition in the opposite direction in response to electricity. The dye may be incorporated in a polymer gel matrix, collectively known as the “switching material” as referenced herein, and this switching material may be sandwiched within a stack of two transparent conductive electrodes (TCEs). The TCEs may include a thin coating of conductive material such as ITO, gold, etc., on the inner surfaces of the sandwich, proximal to the dye-containing polymer gel. Examples of such films may be found in US9588358.

The photochromic-electrochromic example of FIG. 4 may operate with a day mode and a night mode that is either automatically triggered, or it can operate dynamically based on sensor input. When onboard light sensors detect bright ambient lighting conditions (e.g, daylight) a voltage is applied to the adhesive layer 405, which causes lightening of this layer and achieves the high reflectance state when sunlight is reflected off of the mirror 304. When onboard light sensors detect low ambient light conditions (e.g., nighttime or when the vehicle is in a tunnel), the UV LEDs of the LED layer 303 is activated. The UV light from the LED array 303 passes through the mirror 304, darkening the photochromic-electrochromic layer to achieve the low reflectance state. The UV cut-off filter on the outer glass layer 406 prevents the light from exiting the side view mirror assembly, protecting the consumer and also ensuring that inadvertent darkening of the photochromic layer due to sunlight does not occur.

Heating elements may be included in the rear-view mirror to prevent fogging and icing of the mirror. Heating element 102 may be located between backing plate 101 shown in FIGS. 1 through 4, and any of the arrays of LEDs described in the previous examples (namely 103, 203, 303), or between the LED arrays (103, 203, 303) and any of the mirrors described in the previously examples (namely 104, 204, 304). If heating element 102 is located between the LED array and the mirror, it can be comprised of a transparent thin wire or TCE-type heater that is substantially transparent to UV wavelengths as well as wavelengths of light that will cause lightening of the photochromic layers (105, 205, 305, 405).

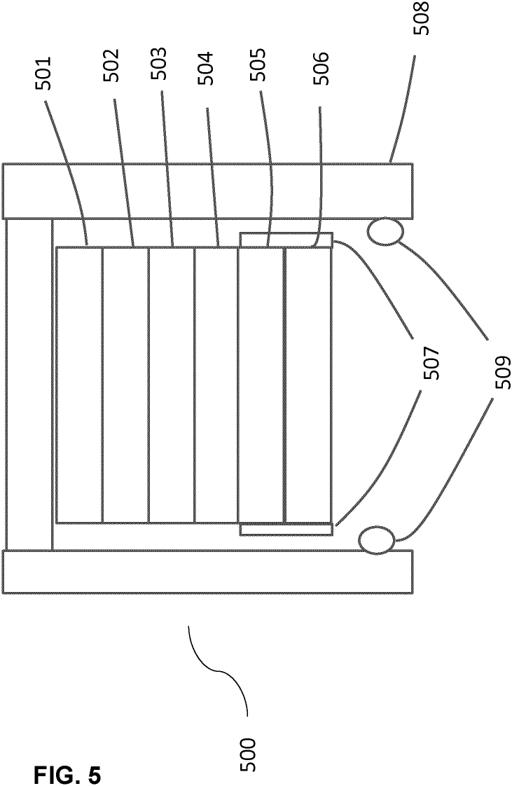

Referring to FIG. 5, a fifth example of a mirror according to the current invention is shown generally as an exploded assembly 500. The LED array 503 in FIG. 5 can comprise one type of LED light as in FIG. 1 where the LED array 103 comprises UV LEDs for darkening the photochromic layer 105, or two types of LEDs as in FIG. 2 where the LED light array 203 comprises LEDs emitting light with wavelengths in the range of to darken the photochromic layer 205, as well as LEDs emitting light with wavelengths in the range of 450 - 800 nm for lightening the photochromic layer 205.

Array 503 is either bonded to the assembly or mechanically attached. A mirror 504, is attached to LED array 503. In an example, mirror 504 has a high transmission in the UV region of the electromagnetic spectrum, high reflectivity in the majority of the visible light region of the electromagnetic spectrum, but may also have high transmission of visible light at the specific wavelength corresponding to the visible LEDs on LED array 503. The mirror 504 may be curved to form a concave or convex surface. In addition, the mirror 504 may have a polarized coating or a polarized film that may be attached using transparent PSA. An outer layer 506 is bonded to layer 505 and is comprised of either glass or plastic. Outer layer 506 may be labeled or etched with text or may be patterned to mask functional elements of the example such as edge seals. In another example, outer layer 506 is comprised of glass, which is curved to form a concave or convex mirror. Outer layer 506 may include coatings on either the inside or outside surfaces. Coatings may include UVAs that will block 99.5% or more of a UV light source. These coatings may be adhered to either surface of outer layer 506 by sputtering, flow coating in an organic matrix, or other deposition technologies known in the art. Outer layer 506 may also comprise a polarized filter, either coated or attached to one face of layer 506 using a plastic film and PSA. The polarized filter of layer 506 must be perpendicularly aligned to the polarized coating or film of mirror 504.

In an alternative example, the mirror comprises an LED array 507 at the side of the stack emitting light with wavelengths in the range of 450 - 800 nm for lightening the photochromic layer 505. This can be in place of LED assembly 503 or in addition to LED assembly 503. The entire mirror assembly is encapsulated in a casing 508. In another alternative example, LED or other light sources 509 emitting light with wavelengths in the range of 450 - 800 nm for lightening the photochromic layer 505 are adhered to this casing. In the case of a sideview mirror, light sources 509 may be directionally pointed in such a manner that the reflected light is not visible to the driver.

The example described herein with reference to FIG. 5 operates with active lightening functionality (visible LEDs) instead of the passive lightening (filtered sunlight). This means that that sunlight is not required to lighten the mirror to put it back into day mode. Even at night the mirror may be switched to provide higher reflectivity. As with the previous example, the mirror can also operate with a day mode and night mode that is either controlled automatically based on time and/or GPS, or based on sensor input, or based on some other feedback. The mirror may also be controlled manually based on user interaction.

In an example of automatic operation, detection of bright ambient lighting conditions (eg. daylight) may cause the visible LEDs in the LED arrays 503 and/or LED array 507 and/or light array 509 to be switched on, which lightens the photochromic layer 505 and achieves the high reflectance state. Using visible LEDs, the lightening of the photochromic layer occurs when light from the visible LED passes through the mirror 504 and its associated linear polarizer to reach the photochromic layer 505, triggering the photochemical lightening reaction to achieve the high reflectance state. Any remaining polarized visible light that is transmitted through the photochromic layer is blocked by the linear polarizer on or attached to outer layer 506. Since the linear polarizer on or attached to outer layer 506 is a crossed polarizer with respect to the linear polarizer on mirror 504, little or no UV light escapes from the front face of the mirror, thereby protecting the user from the LED light.

Similarly, when the onboard light sensors detect low ambient light conditions (e.g., nighttime or tunnel), the UV LED is activated, darkening the photochromic layer to achieve the low reflectance state. The crossed polarizers and/or the optional UV absorber in layer 505 prevent light from the UV LEDs in LED array 503 from escaping the side view mirror assembly in the same way as described above for the visible LEDs. None of the light from LED array 503 (UV or visible), or minimal amounts of it, is able to exit the side view mirror assembly. The UV filter on the outer glass layer 506 also ensures that inadvertent darkening of the photochromic layer 505 due to sunlight does not occur. The mirror 504 reflects incident sunlight providing the mirror functionality for both the high and low reflectance states. Additional light filtering strategies to ensure no light is able to exit the mirror assembly are possible. For example, the pair of crossed polarizers may be replaced by two circular polarizers, where a first polarizer is, for example, a right circular polarizer and a second is a left circular polarizer. In a second example the pair of crossed polarizers may be replaced by a single notch filter on the outer glass, which is selected such that the wavelength of light generated by the visible LED backlight is centered in the reflectance band of the notch filter. In a third example the crossed polarizers may be replaced with a light guide layer between the LED array 503 and the mirror 504 to minimize light exiting the mirror assembly in the direction of the driver or vehicle occupants. One commercially available example of such a light guide layer is ALCF-A2+ from 3M™. In another example only the directional LEDs 509 are used to transition from “night mode” to “day mode” and no polarizers are used in layer 505 and no polarizers or light guide layers are employed between LED array 503 and mirror 504. This is possible because this light is not directional and since it is reflected away from the driver it is not seen during the lightening.

In another example of automatic operation like in the example in FIG. 1, the mirror assembly can be darkened to “night mode” using GPS and time or a sensor technology and remain in “night mode” while driven (or sunlight re-lightening it). However, a sensor can be used to ensure the mirror is automatically reset to “day mode”, either when the vehicle is stopped and the ignition is removed or when the vehicle is entered. In this mode, no polarizers are used in layer 505 and no polarizers or light guide layers are needed in between LED array 503 and mirror 504. Lights from LED arrays 503, 507 or 509 are used to transition from night mode to day mode.

In all of the examples described above, it is also possible to control the mirror to an intermediate state in between the dark state and the low state. This control can be achieved either manually by the user selecting a desired amount of reflectance, or it can be controlled automatically based on sensor input to set the mirror at an optimum state of reflectivity in between the fully dark and fully light states. The control system can also include algorithms to ensure that during daytime operation the minimum reflectance level required by law is achieved.

In an alternate example, the photochromic layer comprises a chromophore that switches from light to dark based on a photochromic reaction, and can also switch from dark to light due to a thermal lightening reaction that occurs above a threshold temperature that is higher than the temperature that would be reached during regular normal operation and higher than the temperature achieved when the mirror defroster is switched on. In an example, the chromophore could fade back to the light state when it is heated above a threshold temperature of 60° C., or above the threshold temperature of 70° C., or above the threshold temperature of 80° C., or above the threshold temperature of 90° C. In this example, the resistive heating element 102 can also be used to transition the photochromic layer back to the light state through a thermal lightening reaction. This can have advantages by not requiring LEDs for one of the switching directions, and also for simplifying the optical filters required. Within the normal operating temperature range of the mirror (e.g., -20° C. to 50° C., or -30° C. to 60° C., or -40° C. to 70° C.), the chromophore remains thermally stable such that the chromophore will stay in the dark state without the need to continually apply UV light, as in some of the prior art examples. In addition the dark and light states only change minimally or not at all within the range of regular operating temperatures; that is, the light and dark states are not temperature dependent over the regular operational temperature range of the mirror.

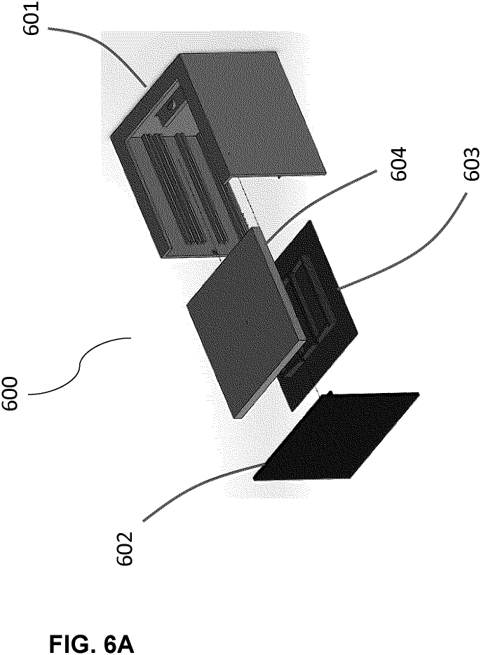

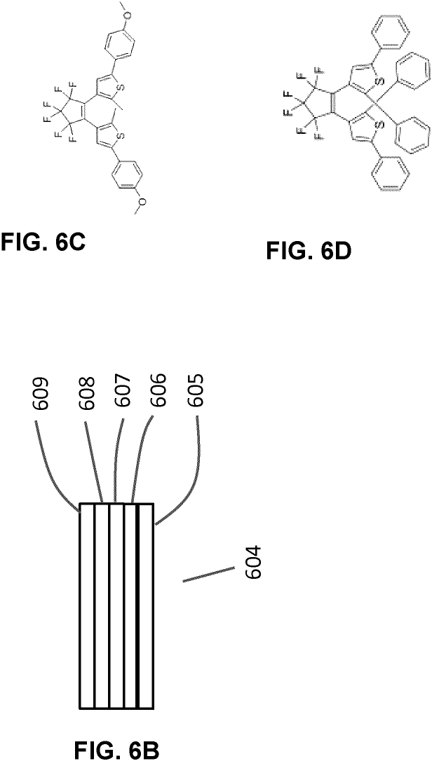

FIG. 6a shows an example of a photochromic mirror built and tested according to the current invention, shown as exploded mirror box enclosure 600. A proof-of-concept prototype mirror was developed according to the example shown in FIG. 1 and its corresponding description. In this example, backing plate 101 and heating element 102 from FIG. 1 were excluded from the prototype build. FIG. 6a shows a general exploded view of the prototype mirror design. LED backlight array 603 was built by fixing two 365 nm LEDs with 875 mW radiant flux (SST-10-UV-A130-E365-00 from Luminous Devices) to a backing plate. Electrical contact points were soldered to the LED array 603, fastened into a mirror box enclosure 601, connected to a power source (not shown), and the enclosure covered with cover plate 602.

FIG. 6b shows the various layers comprised in the mirror stack 604. Photochromic layer 606 was fabricated by gap coating a solution comprising the photochromic chromophore shown in FIG. 6c at 1.8 wt%, a PVB resin from Kuraray Corporation at 20 wt%, and Rhodiasolv IRIS solvent from Solvay onto mirror 605 (5 mm thick Mirropane™ from Pilkington, NSG) using an 8 mil fixed-gap coating bar. The Rhodiasolv IRIS solvent was allowed to evaporate, leaving behind a solid film. The mirror stack 604 further comprises a layer of PVB 607 (Trosifol® Natural UV PVB) followed by a second layer of PVB 608 comprising a 400 nm UV cut-off wavelength (Trosifol® Extra Protect PVB), followed by 2.1 mm thick clear float glass 609. The extra PVB layer was used in this example to provide more effective UV blocking to a higher wavelength. Mirror stack 604 was then laminated together using a vacuum bag process, which consists of subjecting the vacuum bag to a vacuum of -735 mm Hg, heating the vacuum bag to 55° C. for 10 minutes, ramping the temperature up to 135° C. over 15 minutes, maintaining that temperature for 30 minutes and finally cooling the vacuum bag to 60° C. over 10 minutes. The laminated mirror stack 604 was connected into the mirror box enclosure 600 and successfully toggled back and forth between a high reflectance state (approximately 43% reflectivity) and a low reflectance state (approximately 2% reflectivity). By activating the 365 nm LEDs the mirror stack 604 was transitioned to 90% of the fully darkened state in approximately two minutes. Exposure to sunlight of approximately 100 W/m² intensity transitioned the mirror stack 604 back to the light state in approximately 15 minutes.

In another example a photochromic mirror was built and tested according to the current invention. FIG. 6a again shows the general exploded view of the prototype mirror design. LED backlight array 603 was built by fixing two 365 nm LEDs with 875 mW radiant flux (SST-10-UV-A130-E365-00 from Luminous Devices) to a backing plate. Electrical contact points were soldered to the LED array 603, fastened into a mirror box enclosure 601, connected to a power source (not shown), and the enclosure covered with cover plate 602. FIG. 6b shows the various layers comprised in mirror stack 604. In this example photochromic layer 606 was fabricated by gap coating a solution comprising the photochromic chromophore shown in FIG. 6d at 3.6 wt%, a PVB resin from Kuraray Corporation at 20 wt%, and Rhodiasolv IRIS solvent onto mirror 605 (5 mm thick Mirropane™ from Pilkington, NSG) using an 8 mil fixed-gap coating bar. The Rhodiasolv IRIS solvent was allowed to evaporate, leaving behind a solid film. The mirror stack 604 further comprises a layer of PVB 607 (Trosifol® Natural UV PVB) followed by a second layer of PVB 608 comprising a 400 nm UV cut-off wavelength (Trosifol® Extra Protect PVB), followed by 2.1 mm thick clear float glass 609. Mirror stack 604 was then laminated together using a vacuum bag process, which consists of subjecting the vacuum bag to a vacuum of -735 mm Hg, heating the vacuum bag to 55° C. for 10 minutes, ramping the temperature up to 135° C. over 15 minutes, maintaining that temperature for 30 minutes and finally cooling the vacuum bag to 60° C. over 10 minutes. The laminated mirror stack 604 was connected into the mirror box enclosure 600 and successfully toggled back and forth between a high reflectance state (approximately 50% reflectivity) and a low reflectance state (approximately 6% reflectivity). By activating the 365 nm LEDs the mirror stack 604 was transitioned to 90% of the fully darkened state in approximately two minutes. Exposure to sunlight of approximately 200 W/m² intensity transitioned the mirror stack 604 back to the light state in approximately 30 seconds.

One of skill in the art will understand that the percent reflectivity of the mirror stack 604 will be a function of the reflectivity of the mirror 605 utilized and the transmission of the PVB adhesive layers (607 and 608), float glass 609, chromophore type (for example, that shown in FIGS. 6c and 6d) and loading selected. One of skill in the art will further understand that the transition times are a function of the chromophore structure, matrix that the chromophore resides in and light intensity.

### Examples of Photochromic and Photochromic-Electrochromic Switching Materials

Photochromic and photochromic-electrochromic materials can be used to provide the switching function in the rear-view and side-view mirrors according to this invention. Photochromic and photochromic-electrochromic chromophores or dyes absorb visible light in one state (dark state) and allow visible light to pass in another state (light state). The term “chromophore” or “dye” refer to these light absorbing materials and the terms are used interchangeably. Examples of photochromic chromophores suitable for this invention darken (i.e., change to light absorbing mode) in response to light of one wavelength range, and lighten (i.e., change to light transmitting mode) in response to light of a different wavelength range.

For example, suitable chromophores could darken in response to light in the range of 350 - 410 nm, and lighten in response to light in the 450 - 800 nm range. The example chromophores described below for use according to the invention are P-Type photochromic materials, meaning that they are bistable. P-Type photochromic materials are discussed in Pure Appl. Chem, Vol. 73, No. 4, pp. 639-665, 2001; they are familiar to one skilled in the art of photochromic technologies. Once the photochromic chromophore is in the dark state, it will stay in that state until subjected to a stimulus to transition them away from that state. Examples of possible stimuli that can be used to transition the chromophores from one state to another include light of an appropriate wavelength, electricity of an appropriate voltage, or an amount of heat required to raise the temperature of the system above a threshold temperature. This feature has the potential advantage of requiring less power to maintain the rear-view mirror in a certain state (light state or dark state) over a much wider operational temperature range. For example, the photochromic materials described below will persist in the dark or light state over an operational temperature range of -20° C. to 50° C., or over a range from -30° C. to 60° C., or over a range from -40° C. to 70° C., or at least -40° C., or at least -30° C., or at least -20° C., up to about 90° C., or up to 85° C., or up to 80° C., or up to 75° C.

In contrast, T-Type photochromic materials, such as those referenced in prior art US5373392, will thermally revert from the dark state to the light state at lower temperatures. For example, they will switch at temperatures below 70° C., or less than 60° C., or less than 50° C., or less than 40° C., or less than 30° C. in the absence of continuous exposure to UV light. For a photochromic material incorporating a T-Type photochromic compound, the UV LED must remain switched on for the entire time night mode is required, which results in substantially higher power consumption, increased generation of heat that must be dissipated from the mirror assembly, as well a higher requirement for resistance to photochemical degradation.

In other examples, suitable chromophores are photochromic and electrochromic, meaning that one of the transitions (either from the dark state to the light state or vice versa) is driven by light, and the reverse transition is driven by electricity. For example, a photochromic-electrochromic chromophore darkens in response to UV and visible light in the range of 350 - 410 nm and lightens when an electrical voltage is applied across the switching material by way of transparent conductive electrodes that are in contact with the switching material. These photochromic-electrochromic chromophores are also P-Type photochromic materials and will also provide a significant improvement over the T-Type photochromic chromophores used in eyewear and in prior art examples of rear-view mirrors that rely on a thermal back reaction to drive the chromophores into the light state.

Chromophore(s) suitable for use with examples shown in FIG. 1, FIG. 2 or FIG. 3 include classes of compounds from the hexatriene family (e.g. diarylethenes, dithienylcyclopentenes and fulgides), which are photochromic, meaning they interconvert between a colourless or nearly colourless ring-open structure and a coloured ring-closed structure under photochemical conditions. Upon absorption of light of a wavelength of less than 450 nm and more preferably wavelengths less than 400 nm, the chromophore undergoes an electrocyclic ring closing reaction to generate the dark state isomer. Upon absorption of light of wavelengths between 450 -800 nm, the chromophore undergoes an electrocyclic ring opening reaction to generate the light state isomer.

An example of such a chromophore is outlined in US7777055. This material may darken (e.g. reach a ‘dark state’, or “photodarken”) when exposed to ultraviolet (UV) light or light comprising wavelengths from about 350 nm to about 450 nm, and it may lighten (“fade”, “photofade”, “photobleach”, or achieve a ‘light state’) when exposed to light comprising wavelengths from about 450 to about 800 nm. Preferably the chromophore photofades when exposed to sunlight that has passed through a cut-off filter, which filters off light comprising wavelengths shorter than 450 nm (“450 nm cut-off filter”) or shorter than 420 nm (“420 nm cut-off filter”) or shorter than 410 nm (“410 nm cut-off filter”) or shorter than 400 nm (“400 nm cut-off filter”). These chromophores may have an additional structural feature that they undergo a thermal ring-opening reaction above a threshold temperature. These chromophores are categorized as P-Type photochromic materials as this property is different from T-Type photochromic behaviour as defined above in that the P-Type chromophore does not undergo a thermal ring-opening reaction below the threshold temperature. At a temperature equal to or higher than the threshold temperature the P-Type chromophore undergoes a rapid thermal ring-opening reaction. The switching material may be optically clear, or substantially transparent, or not opaque.

Photochromic-electrochromic switching materials are used in the example described with reference to FIG. 4. The photochromic-electrochromic dye reaction is outlined in Formula I. Upon absorption of light of a wavelength of less than 450 nm, the dye undergoes an electrocyclic ring closing reaction to generate the dark state isomer of the dye. When a voltage is applied to the dye, or a light stimulus of greater than 450 nm is applied, the dye switches back to the light state isomer.

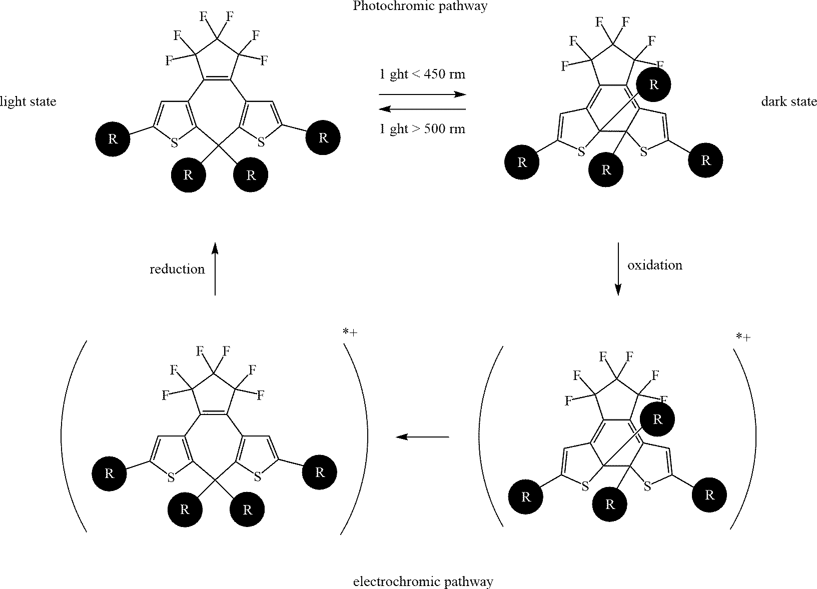

An example of a photochromic/electrochromic “switching material” is outlined in US10054835. This material may darken (e.g. reach a ‘dark state’) when exposed to ultraviolet (UV) light or blue light from a light source, and may lighten (“fade”, achieve a ‘light state’) when exposed to an electric voltage. In some examples, the switching material may also fade upon exposure to selected wavelengths of visible light (“photofade”, “photobleach”), in addition to fading when electricity is applied. In some examples, the switching material may darken when exposed to light comprising wavelengths from about 350 nm to about 450 nm, or any amount or range therebetween, and may lighten when a voltage is applied, or when exposed to light comprising wavelengths from about 450 to about 800 nm. The switching material may be optically clear, or substantially transparent, or not opaque.

### Electronics

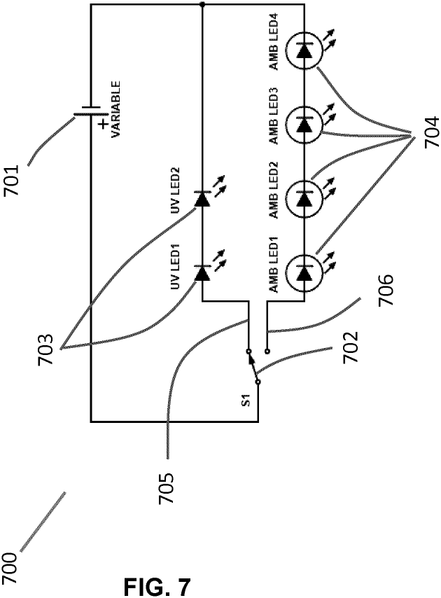

FIG. 7 shows a schematic for a basic circuit 700 for controlling the LEDs used to darken and/or lighten the dynamic mirror. Circuit 700 comprises UV LEDs 703 for darkening a photochromic switching material as well as visible LEDs 704 for lightening the photochromic switching material. However, in some examples, only the UV LEDs 703 are required for darkening because the lightening reaction is triggered by filtered sunlight as in the example described with reference to FIG. 1, or by an electrochromic reaction as in the example described with reference to FIG. 4, or by a thermal lightening reaction triggered at a threshold, as described in US5274132 and US5369158. In these other examples, the visible LEDs 704 are not required. In the example described with reference to FIG. 2, the LEDs 704 are required for lightening the photochromic material. Depending on the particular photochromic material used, the lightening LEDs could be a different colour (i.e., a different wavelength or wavelength range). In some examples, they could be LEDs that emit in the infra-red (IR) range. Regardless of whether they are used for lightening or darkening the photochromic material, LEDs are preferred over other types of light sources (e.g., fluorescent, incandescent, etc.) because of their low power draw, small form factor, and for the ability of LEDs to emit a fairly narrow wavelength range. LEDs are also readily available in many different wavelength ranges, and so can be easily matched to the wavelength required for darkening or lightening a particular photochromic material chosen for the application.

A voltage source 701 provides an appropriate voltage for powering the LEDs. In this case, the voltage source is depicted as a DC voltage, but in other examples AC voltage could potentially be used. In an example, the DC voltage could be the 12 Volts supplied by a standard vehicle battery, or it could be any other voltage. With both UV and visible LEDs present, a switch 702 controls whether current flows to one of two possible circuit paths. In one circuit path 705, the voltage is applied across UV LEDs 703 used for darkening the photochromic film within the mirror. UV LEDs 703 in this case are connected in series such that the voltage being applied is sufficient to light both LEDs. Different LEDs may have different voltage drops and further voltage conditioning circuitry can be provided in order to provide the right voltage across each of the LEDs.

In a second circuit path 706 the voltage is applied across visible LEDs 704. LEDs 704 emit light of a wavelength appropriate for lightening the photochromic layer, for example 405 in FIG. 4, within the assembly (400). The number of LEDs shown in this diagram is four. Wiring these four LEDs in series provides the right voltage drop across each of the LEDs based on the applied voltage 701 to turn them on and run them. However, the number of LEDs for both darkening and lightening should be chosen to provide the necessary amount of light intensity required for darkening and/or lightening the mirror within a set timeframe.

Switch 702 can be controlled manually or controlled through an automated process. In one example, the switch could be controlled based on a clock and/or a GPS signal to determine whether the mirror should be operating in “day mode” or in “night mode”. In another example of an automated system, light sensors could be used to automatically detect light levels and to decide whether the mirror should be lightened or darkened, and then activate switch 702 accordingly to either turn on the UV LEDs 703 or the visible LEDs 704. Note that switch 702 could also have a third “off” position such that no LEDs are connected. This is for the situation when the mirror comprises a switching material that is bi-stable, meaning that once in a certain state (e.g., dark or light) it does not change further without some outside stimulus. So if the mirror is already in the correct transmission level then no LEDs are required to be on to maintain it in that transmission level absent some other external stimulus.

As shown in FIG. 7, the number of UV LEDs 703 required for darkening may be different than the number of visible LEDs 704 required for lightening the photochromic switching material. The electrical circuit can then be designed to provide the appropriate voltage for running the LEDs. Although only a series arrangement of LEDs is shown in this schematic, LEDs can be arranged in series or parallel configurations, or combinations of serial or parallel configurations as required for the specific application.

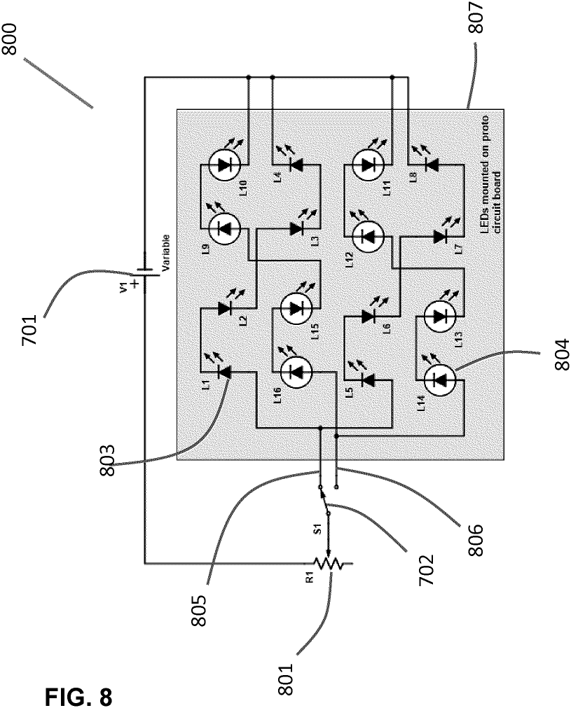

FIG. 8 is an example of sixteen LEDs laid out on a circuit board. The board comprises eight darkening LEDs such as 803, and four lightening LEDs such as 804. A voltage source 701 provides the power for driving the LEDs, and a switch 702 selects between the circuit path 805 comprising the darkening LEDs or the circuit path 806 comprising the lightening LEDs. In this example, the voltage being applied to the LEDs is variable, and can be controlled by a power supply 801. Reducing the applied voltage using power supply 801 can be used to turn off or reduce the brightness of the LEDs, and increasing the applied voltage can serve to increase the brightness of the LEDs. Darkening LEDs such as LED 803 and lightening LEDs such as LED 804 are arranged on circuit board 807 with some darkening and lightening LEDs arranged in each row in order to provide a more uniform light of each type to the photochromic layer. This leads to more uniform darkening or lightening of the photochromic layer.

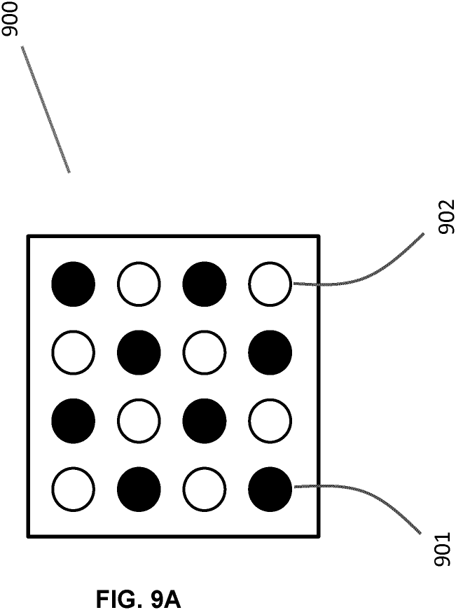

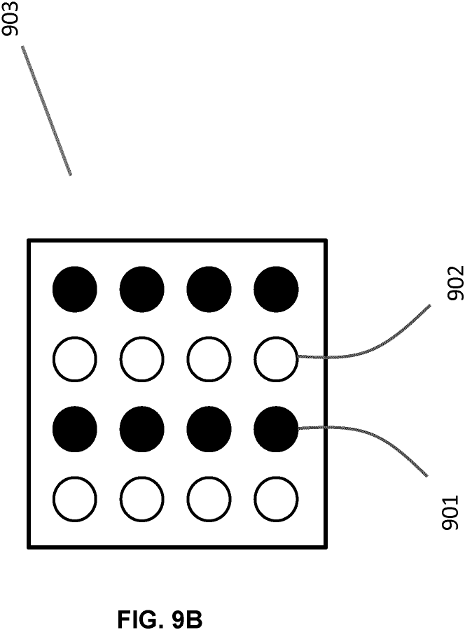

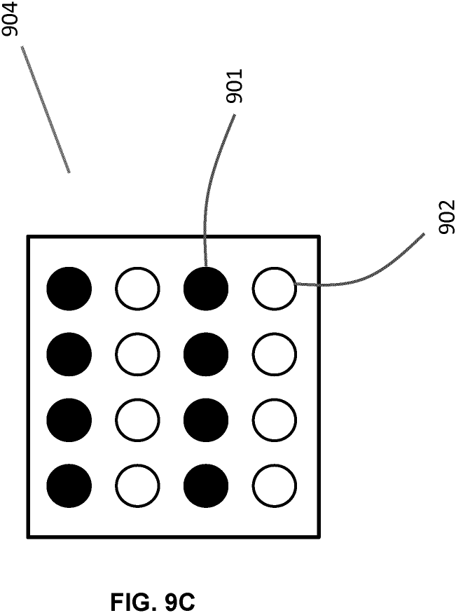

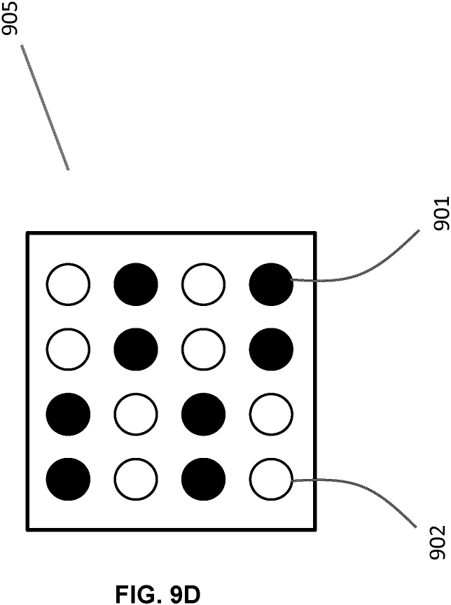

FIG. 9a shows a backlight circuit board 900 with darkening LEDs such as LED 901 interspersed with lightening LEDs such as LED 902. In this example, darkening and lightening LEDs alternate in each row to provide as uniform a light to the photochromic switching material as possible. In this example, 16 LEDs are shown, but any number of LEDs can be used with the alternating pattern to ensure light uniformity. In this case, the circuit board is a square, but in other examples could be any shape in order to fit within the application. FIG. 9b shows a circuit board 903 with another example configuration of the darkening LEDs such as LED 901 and lightening LEDs such as LED 902. In this example, the darkening and lightening LEDs are arranged in alternating vertical rows, which may provide for sufficient uniformity of light for darkening and lightening. The darkening and lightening LEDs can also be arranged in horizontal rows as shown in FIG. 9c on circuit board 904. FIG. 9d shows a circuit board 905 with the example arrangement of the example shown in the schematic of FIG. 8, with darkening LEDs partially alternating within rows and between rows.

Darkening LEDs and/or lightening LEDs can also be arranged to create an LED edge-lit configuration by using LEDs in combination with a light guide film or filter, for example ACRYLITE® LED light guiding edge lit. In this configuration the LED is configured at the edge of the light guide layer and the light is fed in through the edge of the film or filter and emitted uniformly across the surface of the layer. Light diffusing particles embedded in the light guide layer suppress the total internal reflection allowing light to exit the sheet via the surfaces in a controlled and uniform manner. LEDs may be configured on one side of the light guide layer or on two sides of the light guide layer or on any number of sides up to and including each individual side of the light guide layer. The light guide layer may be configured with only darkening LEDs or it may be configured with both darkening and lightening LEDs. Darkening LEDs may be arranged together on the same side of the light guide layer or they may be distributed between two or more sides of the light guide layer. Similarly, lightening LEDs may be arranged together on the same side of the light guide layer or they may be distributed between two or more sides of the light guide layer. Darkening and lightening LEDs may be arranged together on the same side of the light guide layer, alternating between lightening and darkening LEDs, or as a pattern determined by the relative ratio of darkening LEDs to lightening LEDs required for the particular application, for example the repeating pattern of one darkening LED followed by two lightening LEDs. The light guide layer and associated LEDs may be configured behind the mirror or configured in front of the mirror. If the light guide layer is configured in front of the mirror there may be additional design considerations for selecting the light guide layer such as low haze and high optical clarity. Those skilled in the art will understand that the type of light guide layer may be selected based on the size of the area to be illuminated and other design considerations. Other LED configurations are also possible.

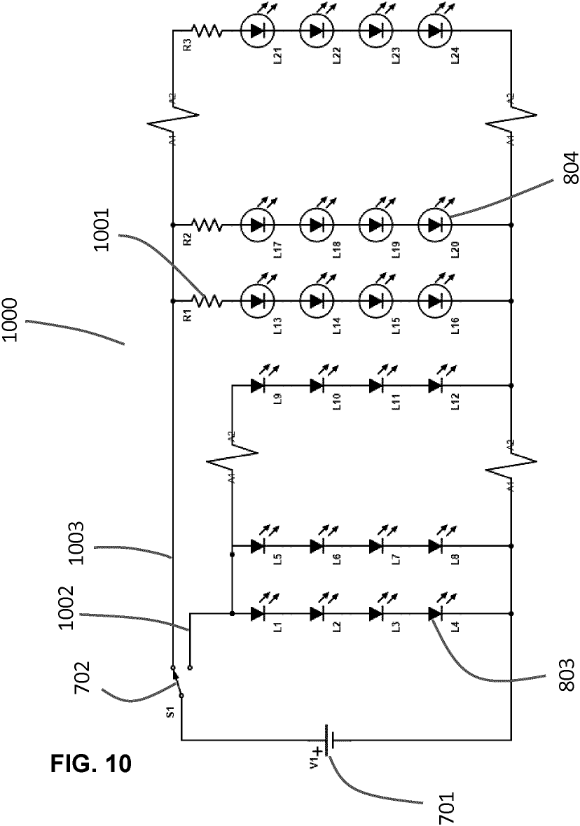

FIG. 10 shows a generalized schematic of this basic circuit showing a voltage source 701, a switch 702 selecting between circuit branch 1002 and 1003, along with darkening LEDs such as LED 803 and lightening LEDs such as LED 804. The diagram shows that any number of darkening LEDs and lightening LEDs can be used to suit the application. In this example the LEDs are shown in a parallel and serial configuration whereby LEDs are connected in series and then in parallel with other strings of LEDs connected in series. The LEDs can be individual LEDs soldered to a circuit board, or they can be strips of LEDs applied to a backplane. Resistors such as 1001 can be used to adjust the voltage drop across the LEDs to provide for the desired voltage. In this case, the resistors are shown modifying the voltage to strings of lightening LEDs arranged in parallel. In place of resistors, switching DC-DC converters can be used to minimize thermal losses resulting from current flowing through the resistors. Many other ways of designing such circuits to achieve the required goals of the switchable mirror are possible and are known to those skilled in the art.

### Other Embodiments

It is contemplated that any embodiment discussed in this specification can be implemented or combined with respect to any other embodiment, method, composition or aspect, and vice versa.

The present invention has been described with regard to one or more embodiments. However, it will be apparent to persons skilled in the art that a number of variations and modifications can be made without departing from the scope of the invention as defined in the claims. Therefore, although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Numeric ranges are inclusive of the numbers defining the range. The terms “approximately” and “about” when used in conjunction with a value mean +/- 10% of that value. In the specification, the word “comprising” is used as an open-ended term, substantially equivalent to the phrase “including, but not limited to,” and the word “comprises” has a corresponding meaning. As used herein, the singular forms “a”, “an” and “the” include plural referents unless the context clearly dictates otherwise. Citation of references herein shall not be construed as an admission that such references are prior art to the present invention, nor as any admission as to the contents or date of the references. All publications are incorporated herein by reference as if each individual publication was specifically and individually indicated to be incorporated by reference herein and as though fully set forth herein. The invention includes all embodiments and variations substantially as hereinbefore described and with reference to the examples and drawings.

Directional terms such as “top”. “bottom”, “upwards”, “downwards”, “vertically”, “laterally”, “inner”, “outer”, are used in this disclosure for the purpose of providing relative reference only, and are not intended to suggest any limitations on how any article is to be positioned during use, or to be mounted in an assembly or relative to an environment.

Unless defined otherwise, all technical and scientific terms used herein have the same meaning as is commonly understood by one of ordinary skill in the art to which this invention belongs. If a definition set forth in this section is contrary to or otherwise inconsistent with a definition set forth in the documents that are herein incorporated by reference, the definition set forth herein prevails over the definition that is incorporated herein by reference.

1. A dynamic mirror assembly that can vary the amount of light reflected, comprising:
a. a mirror; and
b. a switching material, placed between the mirror and a viewer, having a dark state and a light state, that switches state in at least one direction due to a photochromic reaction, and that switches in the other direction due to one or more of a photochromic reaction or an electrochromic reaction or a thermal reversion above a threshold temperature.

2. The dynamic mirror assembly of claim 1, wherein the switching material switches in the other direction due only to a photochromic reaction.

3. The dynamic mirror assembly of claim 1, wherein the switching material switches in the other direction due only to an electrochromic reaction.

4. The dynamic mirror assembly of claim 1, wherein the switching material switches in the other direction due to both a photochromic reaction and an electrochromic reaction.

5. The dynamic mirror assembly of claim 1, wherein the switching material switches in the other direction due to thermal reversion above the threshold temperature.

6. The dynamic mirror assembly of claim 1, wherein the mirror is highly reflective in the visible light region and highly transmissive in the ultraviolet region.

7. The dynamic mirror assembly of claim 1, wherein the mirror is a reciprocal mirror that appears reflective on one side and transparent on the other.

8. The dynamic mirror assembly of claim 1, wherein the switching material comprises a chromophore that switches state in at least one direction due to a photochromic reaction, and that switches in the other direction due to one or more of a photochromic reaction or an electrochromic reaction or a thermal reversion above a threshold temperature.

9. The dynamic mirror assembly of claim 8, wherein the switching material further comprises polyvinyl butyral.

10. The dynamic mirror assembly of claim 1, wherein the mirror comprises one or more of gold, chromium, aluminum, or silver sputtered onto a transparent substrate.

11. The dynamic mirror assembly of claim 1, wherein the mirror comprises a multilayered dielectric material having alternating layers of high and low refractive index materials.

12. The dynamic mirror assembly of claim 8, wherein the chromophore switches via a photochromic reaction to the dark state when excited by light of one wavelength range, and switches via a photochromic reaction to the light state when excited by light of a different wavelength range.

13. The dynamic mirror assembly of claim 1, further comprising light-emitting diodes, on a side of the mirror opposite the switching material, that emit at a fixed wavelength range to drive one of the state changes.

14. The dynamic mirror assembly of claim 13, wherein the light-emitting diodes drive the switching material from the light state to the dark state.

15. The dynamic mirror assembly of claim 13, wherein the fixed wavelength is from about 350 nm to about 410 nm and serves to darken the switching material.

16. A dynamic mirror according to claim 13, further comprising additional light-emitting diodes that emit light within a wavelength range from 450 nm to 800 nm to lighten the switching material.

17. The dynamic mirror assembly of claim 1, further comprising a filter between the switching material and sunlight such that filtered sunlight transitions the switching material from the dark state to the light state.

18. The dynamic mirror assembly of claim 13, further comprising a filter between the switching material and sunlight such that filtered sunlight transitions the switching material from the dark state to the light state.

19. (canceled)

20. The dynamic mirror assembly of claim 1, wherein the switching material comprises a photochromic-electrochromic material, and wherein the switching material darkens in response to light and lightens in response to electricity.

21. The dynamic mirror assembly of claim 1, wherein the switching material comprises a P-Type photochromic material.

22. The dynamic mirror assembly of claim 1, wherein the switching material comprises a photochromic material that switches to the light state photochromically and switches to the dark state due to thermal reversion above the threshold temperature.

23. The dynamic mirror assembly of claim 1, wherein the switching material comprises a photochromic material that switches to the dark state photochromically and switches to the light state due to thermal reversion above the threshold temperature.

24. (canceled)

25. (canceled)

26. The dynamic mirror assembly of claim 1, wherein the threshold temperature is at least 70° C.

27. The dynamic mirror assembly of claim 1, wherein the dark state of the switching material does not spontaneously revert to the light state upon removal of a light source over a temperature range from -20° C. to 50° C., or over a temperature range from -30° C. to 60° C., or over a temperature range from -40° C. to 70° C.

28. The dynamic mirror assembly of claim 1, wherein the dynamic mirror assembly has a day mode and a night mode, and wherein the dynamic mirror assembly is in a high reflectance state during the day mode and in a low reflectance state during the night mode.

29. The dynamic mirror assembly of claim 28, comprising a controller that controls whether the dynamic mirror assembly should be in day mode or night mode based on one or more of a clock, a light sensor, or a GPS signal.

30. (canceled)

31. The dynamic mirror assembly of claim 1, wherein the switching material switches state in at least one direction due to a photochromic reaction, and switches in the other direction due to thermal reversion, wherein the threshold temperature is higher than the regular operational temperature range of the dynamic mirror.

32. (canceled)

33. (canceled)

34. (canceled)
